(19) United States
(12) Patent Application Publication
(10) Pub. No.: US 2023/0141332 A1
(43) Pub. Date: May 11, 2023

(54) STAND DEVICE WITH INPUTS

(71) Applicant: Hewlett-Packard Development Company, L.P., Spring, TX (US)

(72) Inventors: Wei Zhao, Shanghai (CN); Bang-Zhong Xu, Shanghai (CN); Guo-Kai Li, Shanghai (CN); Chun Fu Chen, Taipei City (TW)

(21) Appl. No.: 17/520,043

(22) Filed: Nov. 5, 2021

(51) Int. Cl. G06F 1/16; F16M 13/00; F16B 1/00

(52) U.S. Cl. CPC G06F 1/166; G06F 1/1626; F16M 13/005; F16B 1/00; F16B 2001/0035

(57) ABSTRACT

In some examples, the disclosure describes a device that includes a stand enclosure that includes a first end to interact with a work surface and a second end to be coupled to a display device, a plurality of input ports coupled to the stand enclosure, and a connection interface coupled to the second end of the stand enclosure to allow communication between the display device and the plurality of inputs when the connection interface is coupled to the display device.

### BACKGROUND

Computing devices are utilized to perform particular functions. Computing devices utilize a plurality of components to perform the particular functions. In some examples, a computing device utilizes a device to position a display device associated with the computing device at a level or angle that is viewable by a user.

### BRIEF DESCRIPTION OF THE DRAWINGS

FIG. 1 illustrates an example of a stand device with inputs.

FIG. 2 illustrates an example of a connection interface of a stand device with inputs.

FIG. 3 illustrates an example of a computing device with an electrical connection for a stand with inputs.

FIG. 4 illustrates an example of a system for a stand device with inputs.

### DETAILED DESCRIPTION

A user may utilize a computing device for various purposes, such as for business and/or recreational use. As used herein, the term computing device refers to an electronic device having a processor and a memory resource. Examples of computing devices can include, for instance, a laptop computer, a notebook computer, a desktop computer, an all-in-one (AIO) computer, and/or a mobile device (e.g., a smart phone, tablet, personal digital assistant, smart glasses, a wrist-worn device, etc.), among other types of computing devices. Computing devices can be utilized to perform a plurality of computing functions.

Some computing devices are portable computing devices that include a display device to allow a user to interact with the computing device. In some examples, the computing device may be designed to be hand-held for a period of time. However, a user may also want to utilize the same computing device on a work surface (e.g., desktop, table, etc.). In these examples, the computing device may utilize a stand device to allow the display device to be angled or positioned toward a user without a user having to interact with the computing device. As used herein, a stand or stand device includes a physical device that is able to position a display device in an upright position. In this way, a surface of the display device is positioned at an angle relative to the work surface when the stand device is maintaining the position of the display device, as opposed to the display device lying flat on the work surface. In some examples, the surface of the display device, work surface, and stand form a triangular shape to allow the surface of the display device to be viewable by a user at a particular angle.

In some examples, the portable computing device may not include a plurality of input/output ports or may include a limited quantity of input/output ports to decrease a thickness or size of the portable computing device. For example, the portable computing device can be relatively thinner when particular input/output ports are not embedded within the enclosure of the portable computing device. In this way, an additional device may be utilized to provide the additional input/output ports with the portable computing device.

The present disclosure relates to a stand device that is removably coupled to a computing device or display device with a plurality of input/output ports embedded in the stand device. In this way, additional input/output ports can be provided or utilized with the computing device when utilizing the stand device. In some examples, the stand is communicatively coupled to the computing device through a pogo pin connection interface to allow the plurality of input/output ports to be utilized by the computing device.

In this way, the stand device allows the computing device to be utilized on a work surface and utilize a plurality of additional input/output ports when the stand is connected to the computing device. In addition, the stand is removable from the computing device to allow the computing device to be utilized as a portable computing device such as a tablet device without having the stand connected to the computing device. Furthermore, the stand device is more easily replaceable or maintained compared to a non-removable stand device.

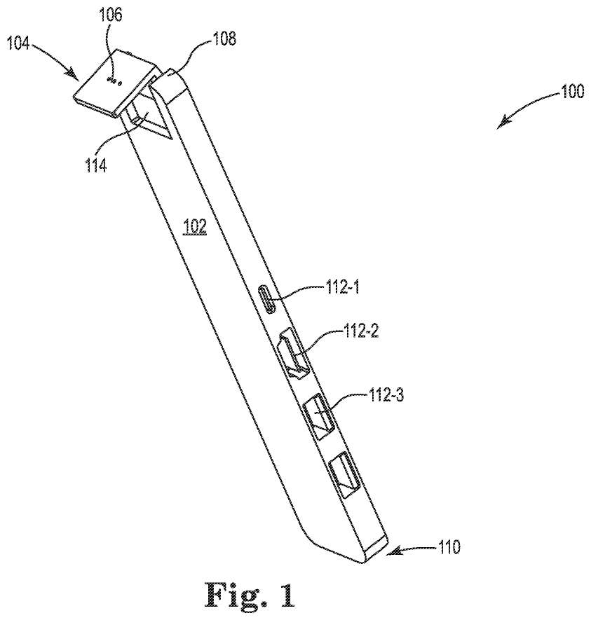

FIG. 1 illustrates an example of a stand device 100 with inputs 112-1, 112-2, 112-3. In some examples, the stand device 100 is a physical device that is capable of maintaining a position of a computing device on a work surface. For example, a first end (e.g., connection interface 104) of the stand device 100 is coupled to a rear surface of the computing device and a second end (e.g., interaction surface 110) interacts with a work surface to allow the computing device to be maintained in an upright position on the work surface. In another example, a connection interface 104 is coupled to a second end of the stand enclosure 102 to allow communication between a display device and the plurality of inputs 112-1, 112-2, 112-3 when the connection interface 104 is coupled to the display device.

In some examples, the stand device 100 includes a connection interface 104 that is coupled to a hinge 108. In one example, the hinge 108 allows an angle between the stand device 100 and a surface of the display device to be altered when stand device 100 is coupled to the display device. The hinge 108 allows the connection interface 104 to rotate relative to the enclosure 102 of the stand device 100. In some examples, the hinge 108 allows the computing device to be positioned at different angles on the work surface.

In some examples, the stand device 100 includes a stand enclosure 102 that includes a first end to interact with a work surface and a second end to be coupled to a display device with a corresponding recessed portion. For example, the connection interface 104 can be coupled to a corresponding connection interface of a computing device. In this example, the hinge 108 allows the enclosure 102 of the stand device 100 to rotate relative to the connection interface 104 while the connection interface 104 remains connected to the computing device. In some examples, the recessed portion of the computing device is to receive the connection interface 104 of the stand device 100. That is, the stand device 100 is removably connected to the computing device such that the stand device 100 is magnetically coupled and electrically coupled to the computing device during use as a stand for the computing device. In this way, the stand device 100 is utilized as a stand and a connection interface for the computing device when the stand device 100 is coupled to the recessed portion of the computing device.

In some examples, the connection interface 104 includes electrical connections 106 that can be coupled to or positioned in contact with corresponding electrical connections of the computing device. In this way, a communication path can be created between the computing device and a plurality of inputs 112-1, 112-2, 112-3. In some examples a communication path includes a path where electrical signals are transferred. In some examples, the communication path is able to transfer electrical signals from the plurality of inputs 112-1, 112-2, 112-3 to the computing device and/or is able to transfer electrical signals from the computing device to the plurality of inputs 112-1, 112-2, 112-3. As described further herein, a plurality of input ports (e.g., plurality of inputs 112-1, 112-2, 112-3) are coupled to or embedded within an edge of the stand enclosure 102.

In some examples, the electrical connections 106 are pogo pin connections. As used herein, a pogo pin connection includes an electrical connection that utilizes a spring-loaded mechanism to provide electrical contact between a first connection and a second connection. In some examples, the spring-loaded mechanism includes a spring device that is positioned between a barrel and a plunger to allow the plunger to be depressed within the barrel when a force is applied to the plunger. In this way, when the plunger is pressed against a corresponding contact the spring force of the spring can provide force on the plunger toward the corresponding contact. Although pogo pin connections are described, other connection types could be utilized.

In some examples, the connection interface 104 includes a magnetic device within an enclosure of the connection interface 104. In some examples, the magnetic device is a permanent magnet or electrical magnet. For example, a permanent magnet can be positioned within the connection interface 104, where the permanent magnet is magnetic continuously. In other examples an electrical magnet is positioned within the connection interface 104. In these examples, the electrical magnet, or electromagnet, is electrically charged through electrical power provided by the computing device through the electrical connections 106. In these examples, the electrical magnet may not provide a magnetic field when the stand device 100 is not coupled to the computing device.

In some examples, the stand device 100 includes a recessed portion 114 to receive the connection interface 104 when the connection interface 104 is rotated to contact the enclosure 102 of the stand device 100. In these examples, the recessed portion 114 allows the connection interface 104 to be stored in a way that protects the electrical connections 106 when the stand device 100 is not coupled to the computing device. As described herein, the electrical connections 106 can be pogo pin connections that are exposed on the surface of the connection interface 104. In this way, the electrical connections 106 are exposed to make contact with other objects when the stand device 100 is not coupled to the computing device.

In some examples, the recessed portion 114 allows the connection interface 104 to be positioned such that a surface of the connection interface 104 is parallel with a surface of the enclosure 102. For example, the connection interface 104 is parallel with the surface of the stand enclosure 102 when the connection interface 104 is in contact with the surface of the stand enclosure 102. In some examples, that makes the stand device 100 easier to store, since the connection interface 104 is not protruding from the surface of the enclosure 102. In other examples, the recessed portion 114 is utilized to protect the hinge 108 and/or connection interface 104 from being broken due to stress. For example, when the connection interface 104 is exposed or is protruding from the surface of the enclosure 102, a force on the hinge 108 or connection interface 104 could potentially damage the hinge 108 or connection interface. In these examples, positioning the connection interface within the recessed portion 114 prevents the connection interface 104 or hinge 108 from interacting with other objects or having excessive force applied, which could damage the connection interface 104 or hinge 108.

As described herein, the stand device 100 includes a plurality of inputs 112-1, 112-2, 112-3. The plurality of inputs 112-1, 112-2, 112-3 include input/output ports that accept a cable or pluggable device. For example, the plurality of inputs 112-1, 112-2, 112-3 can include input/output ports such as, but not limited to: universal serial bus (USB) ports, HDMI ports, USB-C ports, among other types of ports that are connectable to devices or cables of devices. In some examples, the plurality of inputs 112-1, 112-2, 112-3 are embedded within the enclosure 102 of the stand device 100. In some examples, the plurality of inputs 112-1, 112-2, 112-3 are embedded along an edge of the enclosure 102. In some examples, the plurality of inputs 112-1, 112-2, 112-3 can each be an individual and/or different type of input port. For example, a first input may be a USB-B, a second input may be a USB-C, a third input may be an HDMI input, and/or a plurality of additional inputs may be embedded within the edge of the enclosure 102.

In these examples, the plurality of inputs 112-1, 112-2, 112-3 are embedded along an edge that is perpendicular to a surface that interacts with a work surface. For example, the interaction surface 110 interacts with a work surface to maintain the computing device in an upright position. As described herein, the hinge 108 allows the enclosure 102 to make contact with a rear surface of the computing device. In these examples, the plurality of inputs 112-1, 112-2, 112-3 are accessible when the surface of the enclosure 102 interacts or is in contact with the rear surface of the computing device.

As described herein, the plurality of inputs 112-1, 112-2, 112-3 may not be embedded within an enclosure of the computing device to allow the thickness or relative size of the computing device to be reduced. In some examples, the stand device 100 is utilized to provide the plurality of inputs 112-1, 112-2, 112-3 to the computing device when the stand device 100 is coupled to the computing device.

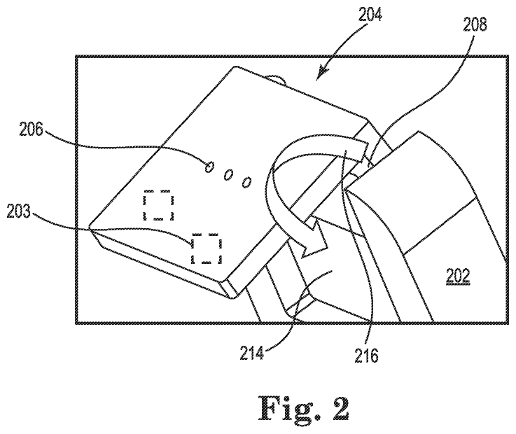

FIG. 2 illustrates an example of a connection interface 204 of a stand device with inputs. As described herein, the connection interface 204 is couplable to a corresponding connection interface of a computing device. In some examples, the connection interface 204 is coupled to an enclosure 202 of the stand device by a hinge 208 that allows the connection interface 204 to rotate along an axis of the hinge 208. In some examples, the connection interface 204 includes the same or similar elements as connection interface 104 as illustrated in FIG. 1.

In some examples, the connection interface 204 includes electrical connections 206 that can provide an electrical connection between a computing device and a plurality of inputs embedded in the enclosure 202. In some examples, the electrical connections 206 can be pogo pin connections that can interact with corresponding pogo pin connections of the computing device. In this way, the pogo pin connections provide an electrical and/or communication path between the computing device and the plurality of inputs. In some examples, the electrical connections 206 can allow the computing device to provide electrical power to the plurality of inputs.

In other examples, the plurality of inputs are coupled to a power source and are capable of providing electrical power to the computing device. For example, one of the plurality of inputs is a USB-C connection that is connected to an electrical outlet or other type of power source. In this example, the power source charges or provides electrical power to the computing device through the USB-C and the connection interface 214. In these examples, the stand device provides an electrical connection to the computing device without utilizing an embedded port of the computing device. This can free up an embedded port of the computing device and/or keep electrical or communication wires behind the computing device during use.

As described herein, the hinge 208 allows the connection interface 204 to rotate in the direction of arrow 216 and/or in a direction opposite to arrow 216. In some examples, the enclosure 202 includes a recessed portion 214 to allow the connection interface 204 to be positioned within the recessed portion 214. In this way, the surface of the connection interface 214 that includes the electrical connections 206 is level with the enclosure 202 and/or positioned in a recessed position compared to the surface of the enclosure 202. As described herein, the recessed portion 214 protects the connection interface 204, hinge 208, and/or electrical connections 206 when the connection interface 204 is positioned within the recessed portion 214.

In some examples, the connection interface 204 includes a magnetic device 203 to interact with a ferromagnetic material positioned within a surface of the computing device. In some examples, the connection interface 204 includes a permanent magnetic device that generates a magnetic field without any electrical power provided to the magnetic device. In these examples, the magnetic device 203 may not utilize electrical power from the computing device to generate the magnetic field. In these examples, the recessed portion 214 can include a ferromagnetic material that can interact with the permanent magnetic device within the connection interface 204. In this way, the connection interface 204 is more securely positioned within the recessed portion 214, which can prevent the connection interface 204 from unintentionally being removed from the recessed portion 214.

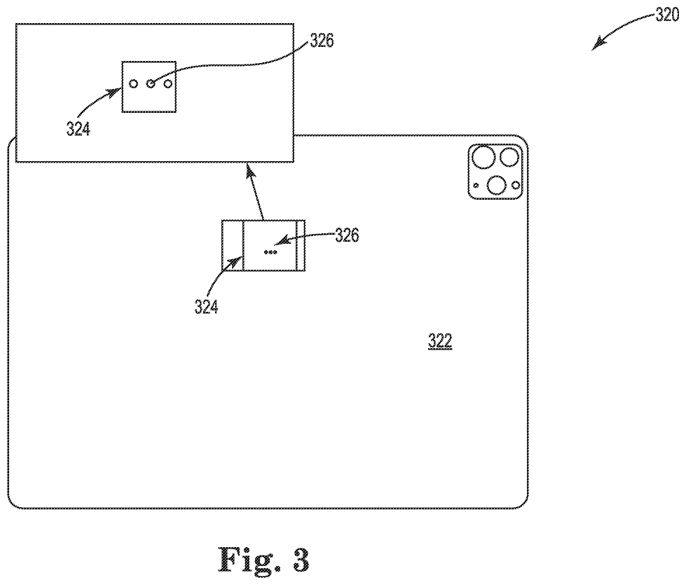

FIG. 3 illustrates an example of a computing device 320 with an electrical connection 326 for a stand with inputs. As described herein, the computing device 320 can be a portable computing device such as, but not limited to: a tablet device, a laptop computing device, an AIO computing device, and/or a smartphone computing device. In some examples, the computing device includes a display device that includes an enclosure that surrounds the display device. In these examples, the enclosure includes a rear surface 322 of the computing device 320 that can be a side that is opposite to the display device or area of the display device that displays images.

In some examples, the computing device 320 includes a processor and a memory resource to store instructions that are executed by the processor. In some examples, the computing device 320 includes a processor and a memory resource storing instructions that can be executed by the processor to perform particular functions. In some examples, the processor executes instructions to receive communication signals from a peripheral device connected to an input/output port embedded in the stand through a connection interface. For example, the computing device 320 can send signals through the electrical connection 326 when a stand device is coupled to the electrical connection 326.

In some examples, the computing device 320 includes a display device that allows a user to interact with the computing device 320. For example, the computing device 320 can include a touchscreen display positioned opposite to the rear surface 322 of the computing device 320. In some examples, the computing device 320 is a device that is designed to be utilized in hands of a user. In this way, the computing device 320 may not include a plurality of input/output ports to decrease a thickness or overall size of the computing device 320.

In some examples, the rear surface 322 of the computing device includes a recessed portion 324 that can receive a connection interface of a stand device (e.g., connection interface 204 of a stand device 200 as referenced in FIG. 2, etc.). In some examples, the recessed portion 324 can be a size and shape that corresponds to a size and shape of the connection interface of the stand device. In some examples, the recessed portion 324 includes a tab portion that can receive a protrusion of the connection interface to further secure the connection interface of the stand device within the recessed portion 324.

In some examples, the connection interface of the stand device can include spring-loaded protrusions that are depressed when positioning the connection interface into the recessed portion 324. In these examples, the recessed portion 324 includes an aperture to receive the spring-loaded protrusions. In this way, the spring force of the spring-loaded protrusions prevent the connection interface from being removed from the recessed portion 324 without overcoming the spring tension applied to the spring-loaded protrusions. In addition, the stand device or connection interface is removable when a force is applied away from the rear surface 322 of the computing device 320 that exceeds the spring tension on the spring-loaded protrusions.

As described herein, the recessed portion 324 includes a coupling mechanism such as a ferromagnetic material that is utilized to further secure the connection interface of a stand device within the recessed portion 324. For example, the connection interface of the stand includes a magnetic device that attracts the ferromagnetic material to provide a magnetic force between the connecting interface of the stand device and the recessed portion 324. In some examples, the ferromagnetic material is positioned proximate to the recessed portion 324 to interact with a magnetic device positioned within the stand. In some examples, the magnetic force between the magnetic device of the connection interface of the stand device and the recessed portion 324 of the computing device 320 can further secure a connection between the electrical connections of the connection interface and the electrical connection 326 within the recessed portion 324.

In some examples, the electrical connection 326 creates an electrical connection with the input/output devices embedded within the stand device. In these examples, the input/output devices are powered or provided with electrical power by the computing device 320 through the electrical connection 326. In some examples, the magnetic interaction between the magnetic device within the connection interface and the ferromagnetic material within the recessed portion 324 maintains the electrical connection when a hinge of the stand device is rotated or moved to different positions. Maintaining the connection between the electrical connection 326 and the stand device when the hinge is rotate ensures that the connection is not lost when a user alters an angle of the display device on a work surface. In this way, a user is able to alter an angle of the display device on the work surface without losing a connection with a device connected one of the plurality of input/output ports.

In some examples, the electrical connection 326 includes pogo pin connections that can correspond to pogo pin connections of a connection interface of a stand device. In some examples, the pogo pin connections utilize a spring-loaded connection to provide a spring force on the connector to ensure an electrical connection is maintained when the stand device is rotated along a hinge.

In some examples, the recessed portion 324 can include a cover or lid that can be rotated to expose the recessed portion 324 and/or the electrical connection 326 within the recessed portion 324. In this way, the rear surface 322 may look and feel like a computing device without the recessed portion 324. In other examples, the recessed portion 324 may provide protection of the electrical connection 326 when the stand device is not connected to the recessed portion 324. For example, the recessed portion 324 allows the rear surface 322 of the computing device 320 to be placed on a work surface without damaging the electrical connection 326.

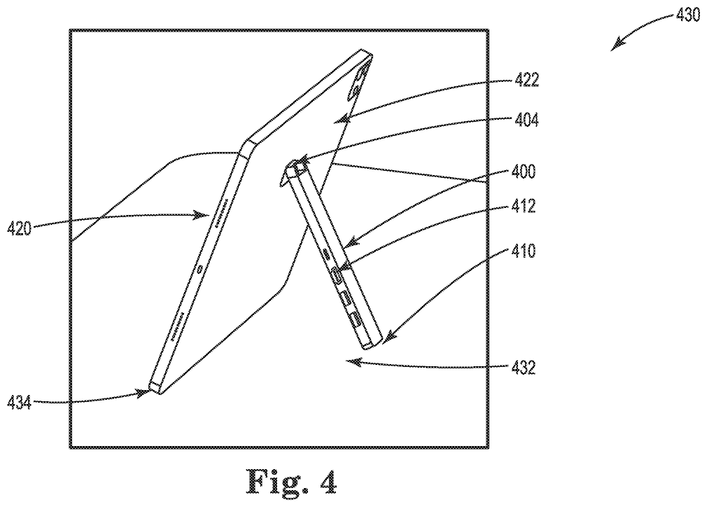

FIG. 4 illustrates an example of a system 430 for a stand device 400 with inputs 412. In some examples, the system 430 illustrates when the stand device 400 is coupled to the rear surface 422 of a computing device 420. In some examples, the system 430 illustrates that a bottom surface 434 interacts with a work surface 432 and maintained at an angle by a stand device 400 interacting with the work surface 432. For example, the stand device 400 includes a surface 410 that interacts with the work surface 432 to position a device (e.g., computing device 420) in an upright position as illustrated in FIG. 4.

In some examples, the stand device 400 includes a plurality of inputs 412. As described herein, the inputs 412 include input/output ports that can be connected to a physical connector and provide a communication path between the inputs 412 and the computing device 420. For example, the inputs 412 are connected to electrical contacts of a connection interface 404 of the stand device 400 and transferred to corresponding electrical contacts within a recessed portion of the rear surface 422 of the computing device 420. That is, a plurality of input/output ports (e.g., inputs 412, etc.) are embedded within the stand 400 and communicatively coupled to the pogo pins of the connection interface 404 of the stand 400.

In some examples, the computing device 420 provides electrical power to the inputs 412, which can provide electrical power to devices or systems that are coupled to the inputs 412. In some examples, the inputs 412 receive data and/or electrical power from peripheral devices connected to the inputs and provide the data and/or electrical power to the computing device 420. In a specific example, the inputs 412 include an HDMI connector. In this example, a peripheral device is coupled to the HDMI connector to display images generated by the computing device 420. In these examples, the peripheral device receives image data and/or audio data through the HDMI connector embedded in the enclosure of the stand device 400.

In a specific example, the inputs 412 includes a USB connector. In this example, a peripheral device is coupled to the USB connector. In this example, the computing device 420 provides electrical power to the USB connector and the computing device receives inputs from the peripheral device through the USB connector. Although specific input/output devices are described regarding the inputs 412, additional inputs or other connections can be utilized with the stand device 400.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and methods of the disclosure. Since many examples can be made without departing from the spirit and scope of the system and method of the disclosure, this specification merely sets forth some of the many possible example configurations and implementations.

What is claimed is:

1. A stand device, comprising:
a stand enclosure that includes a first end to interact with a work surface and a second end to be coupled to a display device;
a plurality of inputs coupled to the stand enclosure; and
a connection interface coupled to the second end of the stand enclosure to allow an electrical connection between the display device and the plurality of inputs when the connection interface is coupled to the display device.

2. The device of claim 1, wherein the second end includes a hinge to allow an angle between the stand and a surface of the display device to be altered when the second end is coupled to the display device.

3. The device of claim 1, wherein the connection interface is coupled to a hinge at the second end of the stand to allow the connection interface to be in contact with a surface of the stand.

4. The device of claim 1, comprising a magnetic device coupled to the second end of the second end of the stand to interact with a ferromagnetic material within the display device.

5. The device of claim 5, wherein the connection interface is parallel with the surface of the stand when the connection interface is in contact with the surface of the stand

6. The device of claim 6, wherein the surface of the stand includes a recessed portion to receive the connection interface when the connection interface is in contact with the surface of the stand.

7. The device of claim 1, wherein the connection interface includes a plurality of pogo pins to allow the electrical connection between the display device and the plurality of inputs.

8. A computing device, comprising:
an enclosure that includes a first side with a display device and a second side with a first connection interface;
a recessed portion of the second side of the enclosure to receive a second connection interface of a stand, wherein the first connection interface is positioned within the recessed portion; and
a processor to receive communication signals from a peripheral device connected to an input/output port embedded in the stand through the first connection interface.

9. The computing device of claim 8, wherein the first connection interface provides signals to the second connection interface when the stand is coupled to the recessed portion.

10. The computing device of claim 9, wherein the second connection interface provides the signals to the input/output port embedded within the stand.

11. The computing device of claim 8, comprising a ferromagnetic material positioned proximate to the recessed portion to interact with a magnetic device positioned within the stand.

12. A system, comprising:
a tablet computing device that includes:
a recessed portion on a rear surface of the tablet computing device;
a first pogo pin connection interface positioned within the recessed portion; and
a ferromagnetic material positioned at the recessed portion; and
a stand that includes;
a second pogo pin connection interface to interact with the first pogo pin connection interface;
an enclosure to interact with a work surface to position the tablet computing device at a particular angle on the work surface; and
a plurality of input/output ports embedded within the stand communicatively coupled to the second pogo pin connection interface.

13. The system of claim 12, wherein the second pogo pin connection is connected to the enclosure through a hinge to allow an angle of the tablet computing device to be altered relative to the work surface.

14. The system of claim 12, wherein the stand includes a magnetic device to interact with the ferromagnetic material and secure the stand to the recessed portion of the tablet computing device.

15. The system of claim 12, wherein the stand includes a recessed portion to receive the second pogo pin connection when the second pogo connection contacts a surface of the enclosure of the stand.
